(19) United States
(12) Patent Application Publication
(10) Pub. No.: US 2016/0362047 A1
(43) Pub. Date: Dec. 15, 2016

(54) Love Steps

(71) Applicants: Anthonie Moore, Lauderdale Lakes, FL (US); Jose Valenzuela, Lauderdale Lakes, FL (US); Genaro Valenzuela, La Puente, CA (US)

(72) Inventors: Anthonie Moore, Lauderdale Lakes, FL (US); Jose Valenzuela, Lauderdale Lakes, FL (US); Genaro Valenzuela, La Puente, CA (US)

(21) Appl. No.: 15/064,520

(22) Filed: Mar. 8, 2016

Related U.S. Application Data
(60) Provisional application No. 62/177,836, filed on Mar. 26, 2015.

(30) Foreign Application Priority Data
Mar. 23, 2016 (US) 15064520

(51) Int. Cl. B60Q 9/00; G08B 21/24; B60R 16/027

(52) U.S. Cl. CPC B60Q 9/00; B60R 16/027; G08B 21/24

(57) ABSTRACT

This child safety device, Love Steps, could be produced easily using conventional and readily available materials and manufacturing processes. No new technology would be required.

The housing for the car seat buckle skirt and the key fob could be molded polycarbonate, polypropylene, or any rigid plastic. The electronic circuitry for the product would utilize printed circuit boards that would mechanically support and electronically connect standard mountable components, such as the RF IC, general purpose IC, relay(s), and a slot assembly for a lithium battery

The concept of Love Steps is a safety device that would prevent injuries and deaths to babies and young children left unattended in motor vehicles. The Love Steps, if manufactured, would make use of readily available technology to warn the driver if a baby or young child was left attended in the vehicle.

The Love Steps would include a battery-operated controller in the form of a keychain device/fob, similar to a car starter or car lock device in size an appearance. The system would also include a “skirt” or sleeve that would fit over the child's car seat harness buckle. The skirt housing assembly would snap into place and would be waterproof.

An open relay built into the skirt would close when the belt flange(s) are inserted into the seat belt lock, closing the circuit and activating the system.

The skirt and fob controller would communicate with each other via infrared RF at a specific frequency. When the distance between the 2 devices (the skirt and fob controller) exceeded 5 feet, the transducer built into the controller would produce a continuous burst of sharp beeps, alerting the driver that the child was still buckled in the seat. When the seat belt was released, the relay would return to its standard open position, and the controller would produce three short beeps to indicate the Love Steps system was disarmed. This would provide the added safety benefit of alerting the parent/driver if the child (or anyone else) unbuckled his seat belt/harness.

The Love Steps could be offered in versions that can be installed on infant/child/toddles car seats, as well as on vehicle seats/seat belts, In addition, original equipment manufacturers (OEM) of child seats and passenger vehicles could incorporate the safety system into new model seats. The Love Steps system could also be updated for school buses and could be offered as OEM equipment or installed as an aftermarket system. In addition, the vehicle seat version would be a valuable safety aid for individuals or companies responsible for transporting elderly or disabled passengers.

### DRAWING DESCRIPTIONS

FIG. 1:

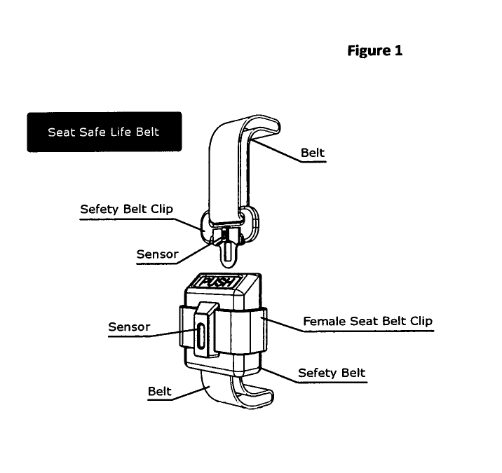

In FIG. 1, what is being shown is the Safety Belt Clip with an attached sensor and the Female Seat Belt Clip with an attached sensor. When the 2 sensors are in close proximity this will create an active, closed circuit, meaning that the system is armed.

FIG. 2:

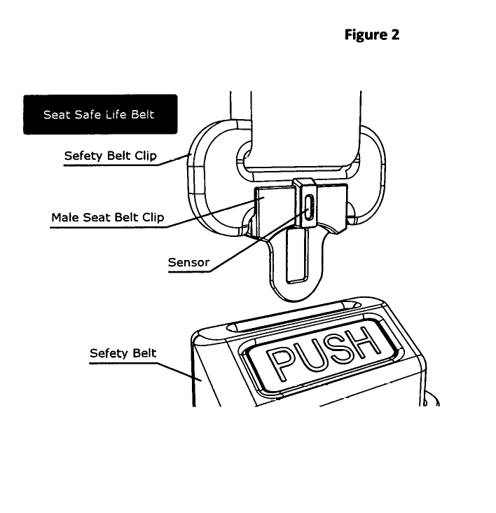

In FIG. 2, what is shown is the Safety Belt Clip, the Male Seat Belt Clip, the attached Sensor and the Safety Belt. Once the Safety Belt Clip is plugged into the Safety Belt, the system is armed.

FIG. 3:

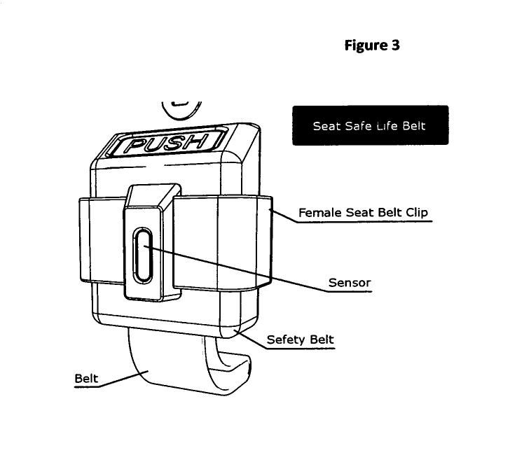

In FIG. 3, what is shown is the Safety Belt Assembly, consisting of the Female Seat Belt Clip, Sensor, Safety Belt and Belt. When the Male Seat Belt Clip is plugged in, the system is armed and active.

FIG. 4:

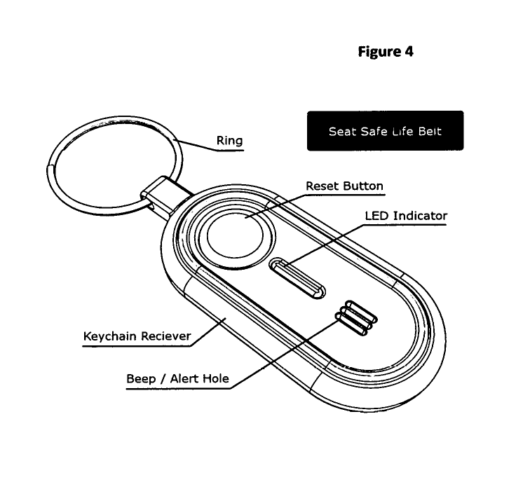

In FIG. 4, what is shown is the controller of the full assembly. When the seat belt assemblies are plugged in, the system is armed and this light is a solid green. This state will remain until the child's safety seat belt assembly is unplugged and the closed circuit changes to an open, or disabled state, and the light will go from green to off. The other scenario is if the adult exits the vehicle without unplugging the seatbelt and leaves the child inside, then after a threshold of 5 feet between the controller and the assembly, the light on the controller will change from green to flashing red, and the built-in transducer will emit 3 short, sharp beeps and 5 sec intervals, until the child's safety seat belt is unplugged

Function and appealing features. This device would fulfill the need for a safety device that would safeguard a baby or young child from being left unattended in a hot vehicle, helping to prevent tragic heat-related injuries or deaths.

The appealing feature of this device would be its automatic activation, the peace of mind enjoyed by busy parents, and the increased safety that could be achieved by babies and young children. The device would sound continuous beeping alarm when the driver (holding the key fob controller) moved away from the vehicle and the buckle skirt sensor

What is claimed is:

1. Assembly for alerting an adult or parent that a child has been left in a vehicle, the assembly, installed on the child car seat, comprising:
A sensor installed adjacent to the flange (latch) to activate the functionality of the assembly, A ‘skirt’ housing whose contents has the electronics (Printer Circuit Board, RE and General Purpose integrated Circuits, normally open Relay), slot assembly for Lithium battery. This sub-assembly is mounted adjacent to the latch release
A sensor mounted on the skirt sub-assembly. This sensor, is configured to active the electronics in the skirt sub-assembly, when the flange sensor is brought in to close proxintly.
A key fob, which is the controller for the assembly, as well as the indicator/warning device that will alert the parent in the event that he or she moves beyond a proximity threshold from the activated circuitry installed on the child seat. 3 sharp beeps every 5 seconds, in addition to constant vibration of the key fob will serve as the indicator that the child is still locked in the seat in the car.
